(19) United States
(12) Patent Application Publication
(10) Pub. No.: US 2017/0057139 A1
(43) Pub. Date: Mar. 2, 2017

(54) Closure and Injection Mold for Its Production

(71) Applicant: Andreas Stihl AG & Co. KG, Waiblingen (DE)

(72) Inventor: Helmut Zimmermann, Berglen (DE)

(21) Appl. No.: 15/228,095

(22) Filed: Aug. 4, 2016

(30) Foreign Application Priority Data
Aug. 26, 2015 (DE) 10 2015 011 207.4

(51) Int. Cl. B29C 45/26; B65D 41/04; B65D 51/28; B29C 45/44

(52) U.S. Cl. CPC B29C 45/2622; B29C 45/44; B65D 41/0442; B65D 51/28; B29C 2045/4485; B29L 2031/565

(57) ABSTRACT

A closure is provided with a closure bottom that is designed to close off a container opening. A circumferential wall is connected to the closure bottom. The circumferential wall has an inner thread that is formed of two or more thread sections spaced apart from each other in a circumferential direction of the circumferential wall. The inner thread has a thread axis. The closure bottom has at least one demolding opening and the at least one demolding opening overlaps at least one of the thread sections, when viewed in the direction of the thread axis of the inner thread. An injection mold with only a first mold half and a second mold half is provided for molding the closure.

### BACKGROUND OF THE INVENTION

The invention relates to a closure and an injection mold for its production. The closure comprises a closure bottom for closing off a container opening and further comprises a circumferential wall wherein on the circumferential wall an inner thread is formed, wherein the inner thread has a thread axis and is formed by at least two thread sections that are spaced apart in the circumferential direction of the closure.

U.S. Pat. No. 4,721,220 discloses a closure to be screwed onto an external thread of a container. The closure comprises an inner thread whose segments in circumferential direction of the closure are positioned separate from each other and do not overlap in vertical direction. Such a closure is produced by injection molding and the core for forming the inner thread is removed after completion of the injection molding process in axial direction of the inner thread with expansion of the circumferential wall of the closure. Due to the segmentation of the inner thread without overlap, the core can be more easily removed because undercuts are formed only by one segment, respectively.

Still, for removal of the core energy must be expended and the material used for producing the closure must have an appropriate flexibility. Moreover, it cannot be precluded that the expansion of the closure required for pulling out the core deforms the closure and damages it permanently.

It is an object of the present invention to further develop a closure of the aforementioned kind such that a simple and inexpensive manufacture is enabled. A further object of the invention resides in providing an injection mold for producing the closure.

### SUMMARY OF THE INVENTION

This object is solved in regard to the closure in that the closure comprises at least one demolding opening arranged at the closure bottom, wherein at least one thread section, viewed in the direction of the thread axis of the inner thread, is overlapped by the demolding opening on the closure bottom of the closure.

In regard to the injection mold, the object is solved in that the injection mold comprises a first mold half and a second mold half, wherein the first mold half comprises a mold wall that molds an exterior side of the circumferential wall of the closure and wherein on the first mold half at least one stay is arranged which extends at a radial spacing relative to the mold wall in the direction of the thread axis, wherein a cavity is formed between the first mold half and the second mold half and wherein the at least one stay projects through the cavity and comprises, relative to the thread axis, a radially outwardly positioned outer surface and, relative to the thread axis, a radially inwardly positioned inner surface that both delimit the cavity.

In connection with the closure according to the invention, it is provided that the closure comprises at least one demolding opening arranged at the closure bottom, wherein at least one thread section, viewed in the direction of the thread axis of the inner thread, is overlapped by the demolding opening at the closure bottom of the closure. By arranging the demolding openings in the closure bottom of the closure, manufacture of the closure by injection molding is possible without use of an injection molding core. The closure according to the invention can be produced with only two mold halves of an injection mold. In this context, the two longitudinal sides of the inner thread of the closure that are positioned opposite each other and are projecting away from the inner side of the circumferential wall of the closure are molded by one of the two mold halves of the injection mold, respectively. The upper first longitudinal side of the inner thread which is facing the closure bottom of the closure is molded by a stay of the first mold half of the injection mold. The two mold halves together form a cavity that is free of undercuts. After hardening of the injected material, the stay of the first mold half can be removed through the demolding opening according to the invention by simply pulling apart the two mold halves. In this way, a simple and fast production of the closure according, to the invention is possible.

Advantageously, for each thread section precisely one demolding opening is provided. Accordingly, by means of the demolding openings, the entire inner thread of the closure can be produced of spaced apart thread sections. Moreover, in this way the cross-sectional surface of the demolding opening can be adjusted, in a direction perpendicular to the thread axis to the size of the cross-sectional surface of an associated thread section, in the direction perpendicular to the thread axis. In this way, the size of the demolding openings provided in the closure is minimal and the closure is stable.

Advantageously, a plurality of demolding openings uniformly distributed about the circumference and a plurality of thread sections are provided. Moreover, it is advantageously provided that the spacing between the demolding openings that are positioned adjacent to each other in circumferential direction is 0.5 times to 2 times, in particular 1 times to 2 times, the thread section length of the thread sections measured in circumferential direction. Due to the arrangement of a plurality of thread sections uniformly distributed about the circumference, a stable inner thread is formed. Since the spacing between the demolding openings positioned adjacent to each other in circumferential direction is 0.5 times to 2 times, in particular 1 times to 2 times, the thread section length of the thread sections measured in circumferential direction, the closure has a satisfactory stability despite the demolding openings.

The closure bottom and the circumferential wall with the inner thread are advantageously formed as a one-piece component. In this way, fewer working steps are required for producing the closure and the stability of the closure is high.

Advantageously, it is provided that the inner thread comprises at most one winding or turn. The inner thread which is formed by the thread sections and is interrupted in circumferential direction extends accordingly across less than 360° about the thread axis on the inner side of the circumferential wall. For several windings or turns, the thread sections would have to be arranged such that they do not overlap in the direction of the thread axis in order to enable demolding. For a single winding or turn, the thread sections can be configured to have a sufficient length so that, by means of the thread sections of the inner thread of the closure, a stable inner thread is formed and the spacing between the thread sections in circumferential direction can be selected to be small without the stability of the closure being greatly reduced by the demolding openings.

Advantageously, it is provided that the closure comprises a profiling at its exterior side. In this way, the closure can be safely and simply gripped and rotated by an operator without slipping off. The profiling imparts increased stability to the closure.

Advantageously, it is, provided that the profiling is formed by ridges that extend in the direction of the thread axis. The ridges that extend in longitudinal direction of the thread axis impart additional stability to the closure in its circumferential direction.

Advantageously, it is provided that the ridges extend all the way onto the closure bottom wherein the ridges in, particular at the closure bottom of the closure project into the space between two neighboring demolding openings. In this way, the area between the holes that are formed by the demolding openings in the closure bottom of the closure are additionally reinforced and stiffened by the ridges. The stiffening of the closure bottom in the area between the demolding openings by means of the ridges leads to an increased stability of the closure and to a pleasing appearance.

Advantageously, it is provided that on the closure bottom an engagement depression for engagement by a tool is formed. A tool can be inserted into this engagement depression for rotating the closure. In this way, unscrewing and tightening of the closure relative to an appropriate counter thread is facilitated. Advantageously, it is provided that on the inner side of the closure a receptacle for a section of a captive securing device is formed. By forming a receptacle for a section of a captive securing device, the closure can be connected to a captive securing device that captively secures the closure on the object to be closed. The receptacle is in particular formed at the end face of the socket. By forming the receptacle at the end face of the socket, the captive securing device can be arranged in the interior of the object to be closed and is safely stored in this way.

Advantageously, it is provided that on the inner side of the closure bottom of the closure a sealing ring contact surface is provided and that a sealing ring is arranged on the sealing ring contact surface. The sealing ring seals advantageously the demolding openings and safely closes off the object to be closed. Accordingly, penetration of dirt through the demolding openings to the interior of the closure can be avoided in a simple way.

An injection mold according to the invention for producing a closure according to the invention comprises a first mold half and a second mold half wherein the first mold half comprises a mold wall that molds an exterior side of the circumferential wall of the closure and wherein on the first mold half at least one stay is arranged which is extending at a radial spacing relative to the mold wall in the direction of the thread axis. A cavity is formed between the first mold half and the second mold half. The at least one stay projects through the cavity. The at least one stay comprises a radially outwardly positioned outer surface relative to the thread axis of the inner thread of the closure and a radially inwardly positioned inner surface relative to the thread axis of the inner thread of the closure. Relative to the injection mold, the thread axis of the inner thread of the closure is the axis which extends in the same position relative to the mold halves in which the thread axis of the inner thread of the closure is extending when the injection mold is closed and contains a closure. The inner surface of the stay as well as the outer surface of the stay delimit the cavity between the first mold half and the second mold half.

With the injection mold according to the invention, the manufacture of the closure according to the invention is possible in a simple way. In this context, the use of an injection mold core that is comparatively complex and must be rotated for demolding is not required according to the invention for molding the inner thread of the closure. This is possible because the closure according to the invention has no undercut. Once the injection molded material has solidified, the produced closure can be removed from the injection mold by simple pulling out the first mold half and the second mold half. The injection mold can be removed from the produced closure without rotation and without expansion. In this way, the injection mold itself as well as the closure are neither subject to wear nor are they damaged. The closure can be made of a shape-stable plastic material with great wall thickness because no expansion of the closure for demolding is required. The closure can be produced in a simple way as a one-piece component by injection molding.

Advantageously, the injection mold is provided with several stays and the stays are spaced apart relative each other in circumferential direction, wherein the end faces of the stays mold segments of a first longitudinal side of the inner thread. In this way, the thread sections of the inner thread of the closure according to the invention are produced without undercuts without requiring use of a mold core. After hardening of the employed injection molding material the stays of the injection mold are pulled out in the direction of the thread axis through the demolding openings extending through the closure bottom.

Advantageously, it is provided that mold sections are formed on the second mold half of the injection mold for molding the segments of the second longitudinal side of the inner thread.

### BRIEF DESCRIPTION OF THE DRAWING

FIG. 1 is a perspective illustration of a closure according to the invention showing a view of the exterior side of the closure bottom.

FIG. 2 is a perspective illustration of the closure of FIG. 1 showing a view of the inner side of the closure bottom and of the circumferential wall.

FIG. 3 is a side view of the exterior side of the circumferential wall of the closure of FIGS. 1 and 2. FIG. 4 is a plan view of the exterior side of the closure bottom of the closure of FIGS. 1 to 3 in the direction of arrow IV in FIG. 3.

FIG. 5 is a plan view of the inner side of the closure bottom of the closure of FIGS. 1 through 4 in the direction of arrow V of FIG. 3.

FIG. 6 is a section view along the section line VI-VI of FIG. 4 with additional illustration of a captive securing device.

FIG. 7 is a section view of a closed injection mold with closure according to FIGS. 1 to 6.

FIG. 8 is a section view of the closure and of the injection mold of FIG. 7 wherein the second mold half has been removed from the closure.

FIG. 9 is a first exploded view of the closure and of the injection mold of FIGS. 7 and 8.

FIG. 10 is a second exploded view of the closure and of the injection mold of FIGS. 7 and 8.

FIG. 11 is a section view of the closure of FIGS. 1 to 10 arranged on a corresponding container.

### DESCRIPTION OF THE PREFERRED EMBODIMENTS

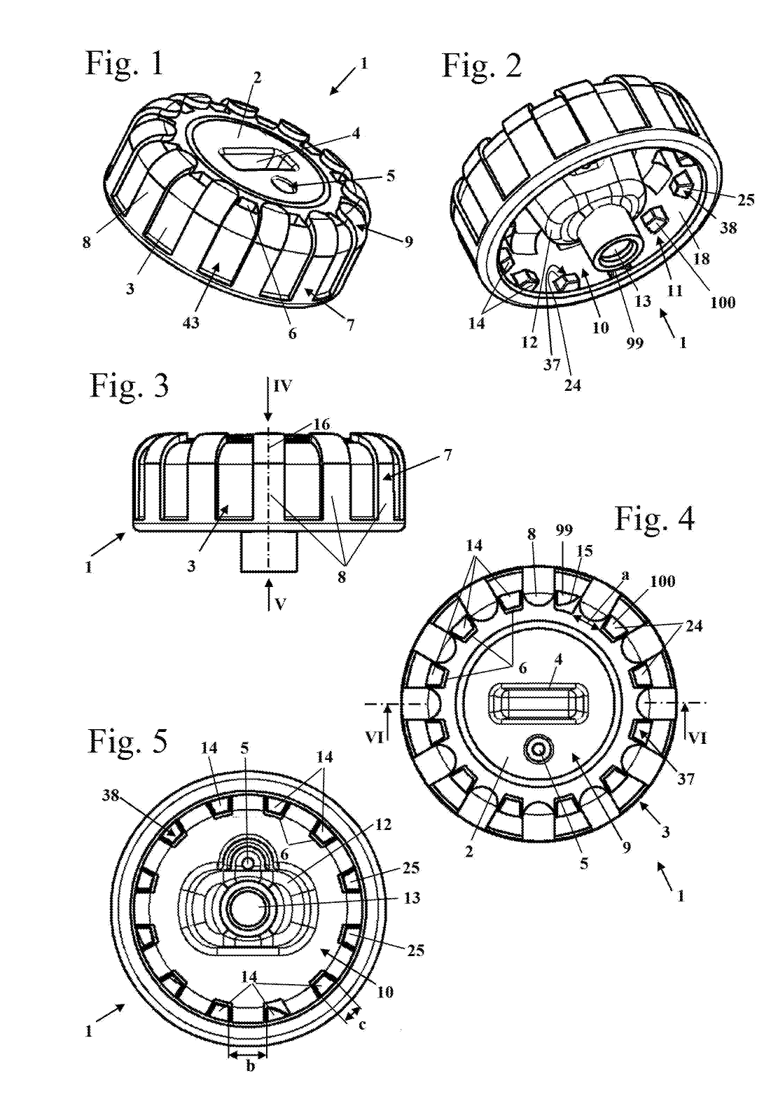

The closure 1 illustrated in FIGS. 1 and 2 is provided for closing a container. The closure 1 serves, for example, for closing a tank, in particular a fuel tank or of tank of a hand-held power tool such as a motor chainsaw, a cut-off device, a trimmer or the like.

The closure 1 comprises a closure bottom 2 that for serves for closing a container opening. A hollow cylindrical circumferential wall 3 is extending away from the rim of the closure bottom 2 and is formed as one piece together with the closure bottom 2.

In the closure bottom 2 of the closure 1, a venting opening 5 is arranged. In the embodiment, the venting opening 5 is a valve that ensures discharge of excess pressure which may be present in the interior of the container that is closed off by the closure 1. The venting opening 5 can also be designed as an air inlet opening.

The closure 1 comprises an exterior side 9 and an inner side 10. The circumferential wall 3 comprises an exterior side 43 and an inner side 18. On the inner side 18 of the circumferential wall 3 an inner thread 11 is formed. It can also be provided that on the circumferential wall 3 an outer thread is formed.

The closure 1 comprises a profiling 7 on its exterior side 9. The profiling 7 is formed by raised portions or ridges 8 on the exterior side 43 of the circumferential wall 3, wherein the raised portions or ridges 8 project in radial direction relative to the thread axis 16 illustrated in FIG. 3. The ridges 8 extend lengthwise in the direction of the thread axis 16 across the entire exterior side 43 of the circumferential wall 3 all the way onto the closure bottom 2 and continue thereon. The ridges 8 are projecting in the direction parallel to the thread axis 16 from the exterior side 9. In the circumferential direction of the closure 1, the ridges 8 are arranged at uniform spacings relative to each other. The profiling 7 formed by the ridges 8 enables a slip-free rotation of the closure 1 for tightening and unscrewing the closure 1 relative to a counter thread of a container opening. The ridges 8 of the profiling 7 project at the closure bottom 2 of the closure 1 into a space between two neighboring demolding openings 6.

On the exterior side 9 of the closure bottom 2, an engagement recess 4 of a substantially rectangular cross-section for engagement of a tool is provided. By rotation of a tool inserted into the engagement opening 4, the closure 1 can be turned for unscrewing or for tightening the closure 1 relative to a counter thread of a container opening.

As shown in FIG. 2, the engagement recess 4 is formed on a socket 12 on the inner side 10 of the closure 1. The socket 12 is provided on the inner side 10 on the closure bottom 2 of the closure 1 and extends in the direction of the thread axis 16. The socket 12 comprises an end face 17. The end face 17 is facing away from the closure bottom 2. On the end face 17, a receptacle 13 for a section of a captive securing device 19 is integrally formed.

The inner thread 11 is formed by several thread sections 14 which in circumferential direction of the closure 1 are spaced apart from each other. The thread sections 14 comprise top sides 24 which are facing the closure bottom 2. The top sides 24 form together the upper first longitudinal side 37 of the inner thread 11. The thread sections 14 comprises bottom sides 25 facing away from the closure bottom 2. The bottom sides 25 form together the lower second longitudinal side 38 of the inner thread 11. The top sides 24 and the bottom sides 25 of the thread sections 14 delimit the thread sections 14 in the direction of the thread axis 16 illustrated in FIG. 3.

FIGS. 4 and 5 show plan views of the exterior side 9 and the inner side 10 of the closure 1. In the closure bottom 2 of the closure 1, the demolding openings 6 are arranged in a circular arrangement in the circumferential direction of the closure 1 about the thread axis 16 (FIG. 3) and are spaced in the circumferential direction at regular spacings relative to each other. The demolding openings 6 are holes in the closure bottom 2 and penetrate the closure bottom 2 completely. In the views according to FIGS. 4 and 5, in the direction of the thread axis 16 illustrated in FIG. 3, the demolding openings 6 have an approximately trapezoidal cross-section. The oppositely positioned parallel sides of the trapezoid surface are rounded. The wider one of the two rounded sides is positioned in this context father removed from the thread axis 16 and is closer to the circumferential wall 3.

In the plan view illustrated in FIG. 4 of the exterior of the closure bottom 2 in the direction parallel to the thread axis 16, the thread sections 14 of the inner thread 11 are visible through the demolding openings 6 extending all the way through the closure bottom 2.

Viewed in the direction of the thread axis 16 of the inner thread 11, the thread sections 14 are located completely within the trapezoidal cross-section of the associated demolding openings 6, respectively. Viewed in the direction of the thread axis 16 of the inner thread 11, each thread section 14 is overlapped by a respective demolding opening 6 on the closure bottom 2 of the closure 1. The cross-section of a demolding opening 6 viewed in the direction of the thread axis 16 is only slightly greater than the cross-section of the correlated thread section 14 in the direction of the thread axis 16. Like the demolding openings 6 the thread sections 14 are uniformly distributed about the circumference of the inner side 18 of the circumferential wall 3 of the closure 1. In total, twelve demolding openings 6 and twelve correlated thread sections 14 are provided. A spacing a between demolding openings 6 positioned adjacent to each other in circumferential direction is 0.5 times to 2 times the thread section length c of the thread section 14 measured in circumferential direction. All twelve thread sections 14 have the same thread section length c in circumferential direction. In the embodiment, the spacing a between the demolding openings 6 adjacently positioned relative to each other in circumferential direction amounts to 1 times to 2 times the thread section length c of the thread sections 14 measured in circumferential direction. Between the thread sections 14 in circumferential direction there is a thread section spacing b. The thread section spacing b between the thread sections 14 adjacently positioned relative to each other in circumferential direction is only slightly greater than the spacing a between the demolding, openings 6 adjacently positioned relative to each other in circumferential direction. The thread section spacing b between the thread sections 14 adjacently, positioned relative to each other in circumferential direction is 0.5 times to 2 times, in particular 1 times to 2 times, the thread section length c of the thread sections 14 measured in circumferential direction.

FIG. 5 shows the inner side 10 of the closure 1 in the direction of the thread axis 16. The inner thread 11 formed by all thread sections 14 extends from a thread beginning 99 about the entire circumference of the inner side 18 of the circumferential wall 3 all the way to a thread end 100 and is formed by all twelve thread sections 14. The thread beginning 99 is formed by the thread section 14 which is farthest removed from the closure bottom 2. The thread end 100 is formed by the thread section 14 which is closest to the closure bottom 2. As shown in FIG. 2, the spacing of the thread sections 14 relative to the closure bottom 2 decreases continuously from the thread beginning 99 all the way to the thread end 100 of the closure 1 in clockwise direction. As illustrated in FIG. 4, the thread beginning 99 has an insertion ramp 15. Accordingly, the thread beginning 99 can be introduced easily into a counter thread. For this purpose, a surface of the thread beginning 99 extending parallel to the thread axis 16 is slanted such that its spacing to the circumferential wall 3, as in FIG. 5, increases continuously in circumferential direction in clockwise direction. The inner thread 11 comprises, as can be seen in FIG. 2, only a single turn. The inner thread 11 extends in circumferential direction across less than 360° of the circumference of the inner side 18 of the circumferential wall 3. Viewed in the direction of the thread axis 16 of the inner thread 11, the thread sections 14 to not overlap each other.

FIG. 11 shows the closure 1 arranged on a container socket 22. The closure 1 closes off the container opening 21 of the corresponding container 20. For this purpose, the closure 1 is screwed onto the container socket 22. The inner thread 11 of the closure 1 and the outer thread 23 of the container socket 22 engage each other. The container socket 22 comprises an end face 44 that is facing away from the container opening 21. A circularly extending sealing ring contact surface 41 is formed on the inner side 10 on the closure bottom 2. Sealing ring 42 is resting on the sealing ring contact surface 41. The sealing ring contact surface 41 and the sealing ring 42 cover or overlap completely the demolding openings 6. The sealing ring 42 extends radially between container socket 22 and inner side 18 of the circumferential wall 3, especially between socket 12 and inner side 18 of the circumferential wall 3.

When the closure 1 is screwed onto the container socket 22 as in the embodiment of FIG. 11, the sealing ring 42 is arranged between the sealing ring contact surface 41 of the closure 1 and the end face 44 of the container socket 22. In this way, the sealing ring 42 in interaction with the closure 1 closes off seal-tightly the container opening 21 The container socket 22 comprises an inner radius r. The inner radius r of the container socket 22 is smaller than the smallest spacing R between the thread axis 16 and the demo ding openings 6. In this way, it is ensured that the sealing ring 42 is pressed by the closure bottom 2 of the closure 1 in circumferential direction of the container socket 22 in continuous engagement against the end face 44 of the container socket 22. In this way, the container opening 21 is completely sealed by the closure 1 in cooperation with the sealing ring 42.

An embodiment without sealing ring can be provided also. As long as the inner radius r of the container socket 22 is smaller than the smallest spacing R between the thread axis 16 and demolding openings 6, the closure bottom 2 of the closure 1 will close the container opening 21 even without sealing ring.

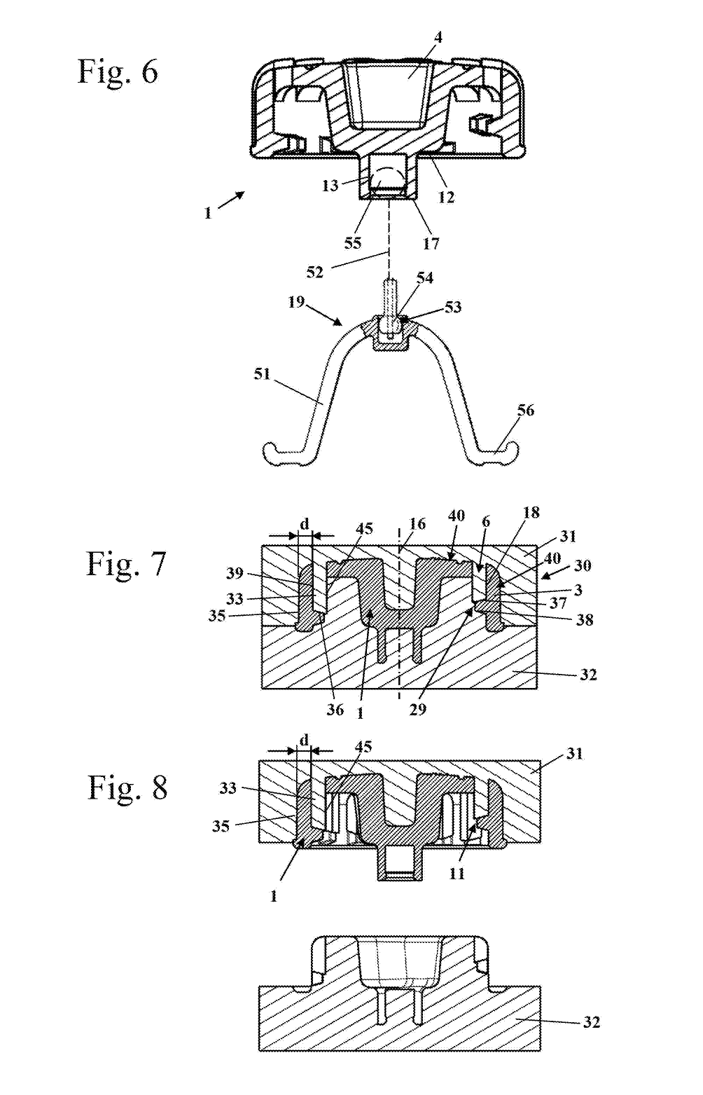

As shown in FIG. 6, the captive securing device 19 is comprised of a bracket 51, a joint element 54, a cable 52, and a fastening element 55. The bracket 51 comprises two hook sections 56 with which it is sup ported on the inner wall of the container 20 (FIG. 11) adjacent to the container opening 21 of the container 20. The spacing of the two hook sections 56 of the bracket 51 is greater than the diameter of the container opening 21 to be closed. The bracket 51 is substantially U-shaped. The hook sections 56 are connected to the open ends of the “U” of the bracket 51 and are angled outwardly relative to “U”. On the tip of the “U” of the bracket 51 which is opposite the open ends a receptacle 53 is provided in which a joint element 54 is rotatably supported and secured to be pivotable about a predetermined angle range. Accordingly, the bracket 51 is secured on the pivot element 54 so as to be rotatable and pivotable a bout the longitudinal axis of the “U”. The joint element 54 is connected by the cable 52 to a fastening element 55. The fastening element 55 of FIG. 6 is spherical. The fastening element 55 is received in the receptacle 13 of the socket 12 of the closure 1.

For protecting against loss of the closure 1, the captive securing device 19 is arranged in the interior of the container 20, illustrated in FIG. 11. When the closure 1 is unscrewed and removed from the container socket 22, the hook sections 56 of the captive securing device 19 contact the wall of the container surrounding the container opening 21. The captive securing device 19 connects the closure 1 with the container 20 even when the closure 1 is not screwed onto the outer thread 23 of the container socket 22 and therefore prevents possible loss of the closure 1.

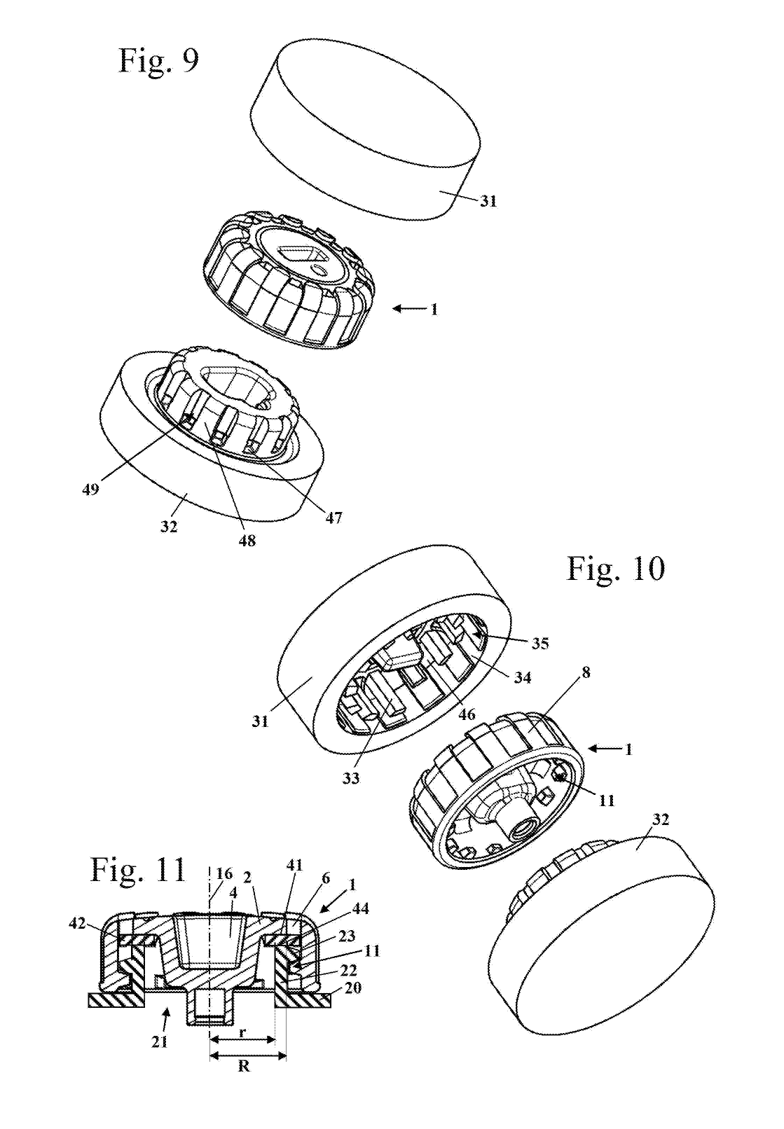

FIG. 7 shows a section of the closure 1 in a closed injection mold 30. The thread axis 16 is located in the section plane. The injection mold 30 comprises a first mold half 31 and a second mold half 32. The first mold half 31 molds large portions of the exterior side 9 of the closure 1 and the second mold half 32 molds large portions of the inner side 10 of the closure 1. The first mold half 31 comprises a mold wall 35 which forms the outer side 43 of the circumferential wall 3 of the closure 1. On the first mold half 31, twelve stays 33 are arranged. The stays 33 extend parallel to the thread axis 16 and spaced from the mold wall 35 at a radial spacing d relative to the thread axis 16. The stays 33 mold the demolding openings 6 as well as a portion of the inner side 18 of the circumferential wall 3. The spacing d corresponds to the wall thickness of the circumferential wall 3 in the area of the stays 33. In circumferential direction of the circumferential wall 3, the wall thickness of the circumferential wall 3 molded by the injection mold 30 corresponds between the stays 33 also to the spacing d. In circumferential direction of the circumferential wall 3, the inner side 18 of the circumferential wall 3 between the stays 33 is molded by an outer surface 48 of the second mold half 32 illustrated in FIG. 9. The outer surface 48 in circumferential direction about the thread axis 16 is interrupted by cutouts 49. In the closed state of the injection mold 30 the cutouts 49 of the second mold half 32 accommodate partially the stays 33 of the first mold half 31.

As illustrated in FIG. 7, between the first mold half 31 and the second mold half 32 a cavity 40 is formed. The stays 33 project through the cavity 40.

The stays 33 have radially outwardly positioned outer surfaces 39 relative to the thread axis 16 and radially inwardly positioned inner surfaces 45 relative to the thread axis 16. The outwardly positioned outer surface 39 is facing away from the thread axis 16. The inwardly positioned inner surface 45 is facing the thread axis 16. The cavity 40 extends on the side of the entire outer surface 39 as well as on the side of a portion of the inner surface 45. The entire outer surface 39 as well as a portion of the inner surface 45 both delimit the cavity 40. The stays 33 mold the demolding openings 6 in the closure bottom 2 of the closure 1.

In FIG. 10, it can be seen that the twelve stays 33 in circumferential direction of the first mold half 31 are arranged, uniformly spaced apart from each other, about the thread axis 16. As illustrated in FIGS. 7, 8, and 10, the stays 33 have end faces 36 that mold an upper first longitudinal side 37 of the inner thread 11. On the second mold half 32 mold sections 47 are formed that mold segments of a lower second longitudinal side 38 of the inner thread 11. The mold sections 47 are formed on ends of the cutouts 49 which are remote from the closure bottom 2.

Profiling 7 on the outer side 43 of the circumferential wall 3 of the closure 1 is formed by the ridges 8 which are extending in the direction of the thread axis 16. As shown in FIG. 10, the ridges 8 in the circumferential wall 3 of the closure 1 are molded by corresponding, recesses 34 in the mold wall 35 of the first mold half 31. The mold wall 35 extends circularly in circumferential direction about the thread axis 16 on a first inner wall of the first mold half 31. The recesses 34 are arranged at regular spacings relative to each other. The recesses 34 are provided across the entire mold wall 35 and also across a portion of the inner side of a bottom 46 of the first mold half 31.

The described injection mold with first mold half and second mold half can also be provided for a closure with outer thread. In this context, by the first mold half the upper first longitudinal side of an exterior thread is molded on the closure, wherein advantageously no demolding openings in the closure bottom are produced. The inner side of the closure is advantageously molded, like the lower second longitudinal side of the outer thread, by the second mold half.

The specification incorporates by reference the entire disclosure of German priority document 10 2015 011 207.4 having a filing date of Aug. 26, 2015.

While specific embodiments of the invention have been shown and described in detail to illustrate the inventive principles, it will be understood that the invention may be embodied otherwise without departing from such principles.

What is claimed is:

1. A closure comprising:
a closure bottom configured to close off a container opening;
a circumferential wall connected to the closure bottom;
the circumferential wall comprising an inner thread comprised of two or more thread sections spaced apart from each other in a circumferential direction of the circumferential wall;
the inner thread comprising a thread axis;
the closure bottom comprising at least one demolding opening, wherein the at least one demolding opening overlaps at least one of the thread sections, when viewed in the direction of the thread axis of the inner thread.

2. The closure according to claim 1, wherein the thread sections each have precisely one of the demolding openings associated therewith.

3. The closure according to claim 1, wherein a plurality of the thread sections are uniformly distributed in the circumferential direction and the thread sections each have a thread section length measured in circumferential direction, wherein a plurality of the demolding openings are uniformly distributed in the circumferential direction at a spacing relative to each other, wherein the spacing is 0.5 times to 2 times the thread section length.

4. The closure according to claim 1, wherein the closure bottom and the circumferential wall with the inner thread are configured as a one-piece component.

5. The closure according to claim 1, wherein the inner thread comprises at most one turn.

6. The closure according to claim 1, wherein the closure comprises an exterior side with a profiling.

7. The closure according to claim 6, wherein the profiling is formed by a plurality of ridges each extending in the direction of the thread axis

8. The closure according to claim 7, wherein the ridges are extending all the way onto the closure bottom and continue on the closure bottom.

9. The closure according to claim 1, wherein the closure bottom comprises an engagement recess configured to be engaged by a tool.

10. The closure according to claim 9, further comprising a socket provided on the closure bottom on an inner side of the closure, wherein the engagement recess is formed in the socket.

11. The closure according to claim 1, further comprising a receptacle configured to receive a section of a captive securing device, wherein the receptacle is formed on an inner side of the closure.

12. The closure according to claim 1, further comprising a sealing ring contact surface disposed on the closure bottom on an inner side of the closure and further comprising a sealing, ring arranged on the sealing ring contact surface.

13. An injection mold for producing a closure according to claim 1, the injection mold comprising:
a first mold half and a second mold half;
wherein the first mold half comprises a mold wall configured to mold an exterior side of the circumferential wall of the closure;
wherein the first mold half comprises one or more stays extending at a radial spacing relative to the mold wall in a direction of a thread axis of an inner thread of the closure;
wherein between the first mold half and the second mold half a cavity is formed;
wherein the one or more stays project through the cavity and each comprise a radially outwardly positioned exterior surface relative to the thread axis of the inner thread and a radial inwardly positioned inner surface relative to the thread axis of the inner thread, wherein the radially outwardly positioned exterior surface and the radial inwardly positioned inner surface delimit the cavity.

14. The injection mold according to claim 13, wherein a plurality of the one or more stays are provided so as to be spaced apart from each other in a circumferential direction of the first mold half, wherein end faces of the stays are configured to mold segments of a first longitudinal side of the inner thread.

15. The injection mold according to claim 14, wherein the second mold half comprises mold sections that are configured to mold segments of a second longitudinal side of the inner thread.
